(19) United States
(12) Patent Application Publication
(10) Pub. No.: US 2005/0052416 A1
(43) Pub. Date: Mar. 10, 2005

(54) Pointing device

(76) Inventors: Jonas Backman, Danderyd (SE); Kurt Hognelid, Bromma (SE); Frodrik Madsen, Stockholm (SE); Magnus Schnurer, Bromma (SE); Tomas Oquist, Upplands Vasby (SE)

Correspondence Address: McCormick Paulding & Huber, CityPlace II, 185 Asylum Street, Hartford, CT, 06103-3402, US

(21) Appl. No.: 10/497,801

(22) PCT Filed: Dec. 5, 2002
(86) PCT No.: PCT/SE02/02241

(30) Foreign Application Priority Data
Dec. 6, 2001 (SE) 0104110-2

(51) Int. Cl. G09G 5/08

(52) U.S. Cl. 345/163

(57) ABSTRACT

A primary pointing device controls the position of a cursor on a digital screen by means of primary position commands (C₁). The primary position commands (C₁) are generated by relative movement (D¹₁; D¹₂) between the primary pointing device and a substantially flat external surface, such as a tabletop or mouse pad. The primary pointing device is adapted to dock with a secondary pointing device, which may also control the position of the cursor on the digital screen. Bearing registering user input controls in the secondary pointing device generate secondary position commands (C₂), which are fed to the digital processor for causing the cursor to move on the digital screen. Furthermore, the primary pointing device is adapted to dock with the secondary pointing device.

### CROSS-REFERENCE TO RELATED APPLICATIONS

This application is entitled to the benefit of and incorporates by reference essential subject matter disclosed in International Application No. PCT/SE02/02241 filed on Dec. 5, 2002 and Swedish Patent Application No. 0104110-2 filed on Dec. 6, 2001.

### FIELD OF THE INVENTION

The present invention relates generally to the production of position related commands for controlling graphical events on a digital screen. More particularly the invention relates to a primary pointing device according to the preamble of claim 1 and a multifunction pointing device according to the preamble of claim 11.

### BACKGROUND OF THE INVENTION

The trend in both telecommunication and data processing is towards mobility, decreased device sizes and application specific interfaces. Moreover, our manners of interacting with computers and various communication tools is becoming less orthodox. For example, it cannot be presupposed that the user predominantly sits at a desk when operating his/her computer. Together, these circumstances place an increased demand for user-friendly and flexible data input arrangements. One way of accomplishing such arrangement would be to provide a portable pointing device, which for example, is attachable to a user's hand and that communicates wirelessly with a computer. The user is thereby free to move relative to the computer and its digital screen, while at the same time, he/she maintains the ability to interact with the computer. Moreover, this arrangement increases the user's chances of finding a comfortable and ergonomically appropriate working posture.

However, certain applications and work tasks may be less suited for interaction via a portable pointing device. For instance, in situations where a relatively high positioning accuracy is demanded, the user may prefer to rest his/her lower arm against a steady support and perhaps make use of a comparatively large area and/or range of movement to generate the position commands. Hand held devices, such as the above-mentioned pointing device, generally allow only a rather short range of movement (or input area). Typically, they also provide a relatively low degree of physical support for the user's arms, hands and fingers.

Therefore, although a non-desktop working posture is generally preferable for interaction with most applications, a user equipped with a portable pointing device should not be restricted from employing alternative or complementary pointing devices in situations where this is warranted. In fact, the variation itself of the working posture is advantageous from an ergonomic point of view, even if the standard working posture already is ergonomically correct. Varying the working posture namely reduces the static exertion on the body and stimulates an adequate blood flow through the body.

### SUMMARY OF THE INVENTION

The object of the present invention is therefore to provide a flexible solution for entering position related commands into a digital processor, which alleviates the problems above and thus allows the user to chose a working posture being optimal with respect to the requirements of the work task as well as the user's personal preferences.

According to one aspect of the invention the object is achieved by a primary pointing device for controlling the position of a cursor on a digital screen as initially described, which is characterized in that it is adapted to dock with a secondary pointing device for controlling the position of the cursor on the digital screen. The secondary pointing device generates the secondary position commands, by manipulation of at least one bearing registering user input control. The secondary position commands are processed by the digital processor, which then causes the cursor to move on the digital screen.

Naturally, the primary and the secondary pointing devices may represent any geometrical shape and design, which allows them to dock and thus be physically connected to each other. The ability to dock the primary pointing device with a secondary pointing device is advantageous since this allows the user to, in addition to a conventional use of the device, operate it as a pointing device having all the capabilities of an alternative pointing device, for example a portable unit.

According to a preferred embodiment of this aspect of the invention, the primary pointing device comprises a battery charger. The battery charger has a docking interface, which is adapted for reception of the secondary pointing device such that it may charge at least one rechargeable battery cell therein. It is, of course, advantageous to include a battery charger in the primary pointing device, since many interesting applications for any secondary pointing device imply that this unit has a wireless communication interface and therefore requires a separate power source in the form of an electrical battery. Most preferably, this battery should also be rechargeable. Naturally, both the primary and the secondary pointing device may be operated by the user while the battery cell in the secondary pointing device is being charged.

According to another preferred embodiment of this aspect of the invention, the secondary pointing device comprises a U-shaped holding member, which is adapted for attachment to a human hand. Furthermore, the docking interface is adapted to receive this U-shaped holding member, such that a physical connection between the primary pointing device and the secondary pointing device may be accomplished here. A secondary pointing device being at least partly U-shaped is normally desirable both from an ergonomic—and a user friendliness point of view. It is also desirable to arrange a docking interface on the primary pointing device, which is adapted to said U-shape since this results in a an overall shape of the primary pointing device that likewise is appropriate with respect to ergonomics.

According to yet another preferred embodiment of this aspect of the invention, the docking interface is further adapted to receive the secondary position commands from the secondary pointing device when the secondary pointing device is connected to the primary pointing device. An advantage attained thereby is that the position commands from the two pointing devices can be coordinated, such that a desired control with respect to the cursor is accomplished efficiently.

According to still another preferred embodiment of this aspect of the invention, the primary pointing device also comprises a transformation unit, which converts the secondary position commands received via the docking interface into corresponding primary position commands. These commands may thus be forwarded to the digital processor via a communication interface that normally is used for transporting primary position commands from the primary pointing device. This is desirable, i.a. since it facilitates the processing of the position commands on the digital processor side.

According to a preferred embodiment of this aspect of the invention, the primary position commands are presumed to represent a first type of cursor positioning while the secondary position commands are presumed to represent a second type of cursor positioning. Technically, the first and the second type of cursor positioning may be identical. However, it is generally more useful if they are non-identical, because different types of positioning may be efficient/appropriate in different work situations and/or applications. Hence, a separation of the types of positioning between the primary and the secondary pointing device allows the user to simultaneously or alternately take advantage of at least two different types of positioning, both when the devices are connected to each other and when they are separated from each other.

According to one preferred embodiment of this aspect of the invention, the first type of cursor positioning represents a relatively high accuracy with respect to cursor movements on the screen. The second type of cursor positioning, on the other hand, represents a relatively low accuracy with respect to cursor movements on the screen. An advantage attained thereby is that the second type of positioning may, for example, be used for moving the cursor long distances, whereas the first type of positioning may be used for small cursor movements and/or whenever a high precision is required.

According to another preferred embodiment of this aspect of the invention, the first type of cursor positioning causes the cursor to move along a first direction, say vertically, on the digital screen and the second type of cursor positioning causes the cursor to move along a second and different direction, say horizontally. Such separation of the directions is sometimes advantageous, because it results in a very efficient user interaction with respect to certain applications.

According to a first alternative preferred embodiment of this aspect of the invention, the primary pointing device comprises a wireless communication interface for transmitting the primary position commands to the digital processor. A wireless communication interface (e.g optical or radio) is desirable whenever the user requires a flexible and relatively unconstrained interaction with the digital processor.

According to a second alternative preferred embodiment of this aspect of the invention, the primary pointing device instead comprises a cable interface for transmitting the primary position commands to the digital processor. It is true that this kind of interface is less flexible than a wireless ditto. However, a cable interface may still be advantageous. For example, the cable can also be used to transport electrical energy to the primary pointing device, such that the device does not need a power supply of its own.

According to another aspect of the invention, the object is achieved by a multifunction pointing device as initially described, which is characterized in that the secondary pointing device is detachable from the primary pointing device. Moreover, the primary pointing device and the secondary pointing device may be operated separately. Specifically, this means that when the secondary pointing device is detached from the primary pointing device, the cursor moves on the digital screen either in response to the primary position commands or in response to the secondary position commands. The cursor may also move in response to a combination of the primary position commands and the secondary position commands.

This design provides a great flexibility while maintaining the capabilities of each pointing device, irrespective of whether the secondary pointing device is attached or not, and is thus very advantageous.

According to a preferred embodiment of this aspect of the invention, the secondary pointing device comprises a rechargeable battery cell. Furthermore, the primary pointing device includes a battery charger for charging the rechargeable battery cell when the secondary pointing device is connected to the primary pointing device. As mentioned earlier, it is advantageous to include a battery charger in the primary pointing device, since many of the interesting applications for the secondary pointing device imply that this unit has a wireless communication interface and therefore requires a separate power source, in the form of e.g. a rechargeable electrical battery.

According to a first alternative preferred embodiment of this aspect of the invention, the primary pointing device comprises a wireless communication interface for transmitting the primary position commands to the digital processor. Again, a wireless communication interface is desirable whenever the user requires a flexible and relatively unconstrained interaction with the digital processor.

According to a second alternative preferred embodiment of this aspect of the invention, the primary pointing device instead comprises a cable interface for transmitting the primary position commands to the digital processor.

According to yet a preferred embodiment of the second alternative embodiment of the invention, the cable interface includes at least one wire for transporting electrical energy to the primary pointing device. Consequently, the primary pointing device does not need a power supply of its own and can thereby be made lighter, less complex and less expensive.

According to still another preferred embodiment of this aspect of the invention, the multifunction pointing device contains a docking interface for receiving the secondary position commands from the secondary pointing device when the secondary pointing device is connected to the primary pointing device. The multifunction pointing device also includes a transformation unit for converting the secondary position commands into primary position commands, which are adapted for forwarding to the digital processor. The secondary position commands may thus be forwarded to the digital processor via a communication interface that normally is used for transporting primary position commands from the primary pointing device. This is generally desirable, because the processing of the position commands may thereby be facilitated on the digital processor side.

To summarize, the invention offers a wide range of possibilities for the user of a computer, data—or telecommunication device to vary his/her working posture and thus find a means of interaction with the device, which is optimized both with respect to the work task and with respect to an ergonomic point of view.

### BRIEF DESCRIPTION OF THE DRAWINGS

The present invention is now to be explained more closely by means of preferred embodiments, which are disclosed as examples, and with reference to the attached drawings.

FIG. 1 depicts a primary and a secondary pointing device according to an embodiment of the invention,

FIG. 2 shows an arrangement according to an embodiment of the invention, which includes the proposed primary and secondary pointing devices,

FIG. 3 illustrates a first alternative embodiment of a multifunction pointing device according to the invention, and

FIG. 4 shows a second alternative embodiment of a multifunction pointing device according to the invention.

### DESCRIPTION OF PREFERRED EMBODIMENTS OF THE INVENTION

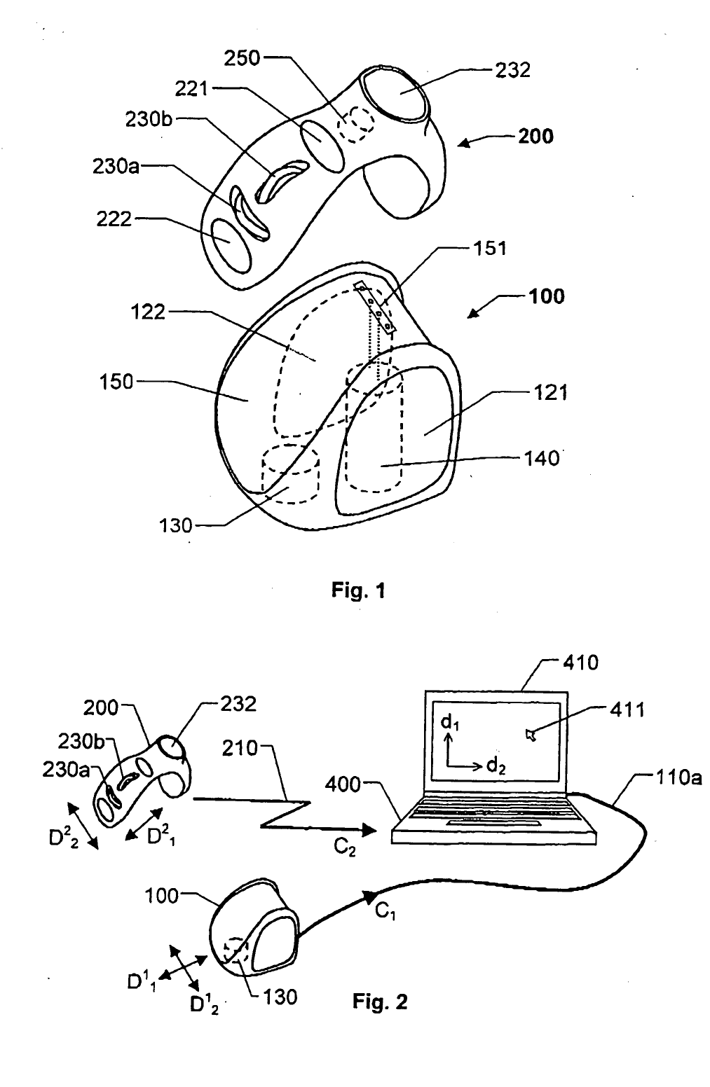

FIG. 1 shows a respective semi-transparent representation of a primary pointing device 100 and a secondary pointing device 200 according to an embodiment of the invention. Both the devices 100 and 200 are adapted for controlling the position of a cursor on a digital screen of arbitrary computer or communication device. The primary pointing device 100 includes a bearing registering sensor 130, which registers relative movements between the primary pointing device 100 and a substantially flat external surface and render these movements adapted for interpretation as position commands to control a cursor. The bearing registering sensor 130 preferably records movements in two dimensions and may operate according to any known technology in the field. For instance, it may include a ball, an optical sensor or another non-mechanical sensor (e.g. capacitive or resistive). Furthermore, the sensor 130 may either be adapted for registering movements of the primary pointing device 100 relative an external surface that is stationary, or vice versa, presuppose that the primary pointing device 100 is stationary and register movements of a comparatively small external surface, such as a fingertip. Preferably, the primary pointing device 100 also includes so-called mouse buttons 121 and 122 for input of various commands from the user in relation to the cursor's current position. Furthermore, the primary pointing device 100 may include one or more modules for processing various position commands and other user-generated inputs.

The secondary pointing device 200 also contains bearing registering means for receiving position commands from a user. According to a preferred embodiment of the invention, these means are different from the bearing registering sensor 130 in the primary pointing device 100, at least in one respect. For instance, the bearing registering user input control could be combined with a confirmation—or click-function being included in a touch pad, a joyball or a joystick 232. In addition to this, or as an alternative, the secondary pointing device 200 could include one or more scroll wheels 230a and 230b for registering positioning commands with respect to certain directions. Preferably and in analogy with the primary pointing device 100, the secondary pointing device 200 also includes mouse buttons 221 and 222 for registering commands from the user, which are related to the cursor's current position.

As can be seen in the figure, the secondary pointing device 200 comprises a generally U-shaped lower portion having two legs. The shape of this portion is adapted for attachment to a human hand in order to enhance the usability of the device 200. Naturally, the device 200 may equally well be operated by any other means, for example by the user holding it in one or both hands.

The primary pointing device 100 comprises an upper portion in the form of a docking interface 150, which is adapted to the U-shaped member of the secondary pointing device 200, such that a physical connection may be accomplished between the primary pointing device 100 and the secondary pointing device 200 by placing the secondary pointing device 200 on top of the primary pointing device 100. A contact 151 in the docking interface 150 contains leads, which are electrically connected to a battery charger 140 in the primary pointing device 100. When the secondary pointing device 200 is connected to the primary pointing device 100, the battery charger 140 may thus charge a rechargeable battery cell 250 in the secondary pointing device 200. The battery charger 140 itself may either receive its electrical energy from a battery inside the primary pointing device 100 (rechargeable or single-use) or be connected to an external power source.

According to a preferred embodiment of the invention, the contact 151 also includes one or more leads or connectors for exchanging information between the devices 100 and 200. According to another preferred embodiment of the invention, the devices 100 and 200 instead exchange information over a wireless interface, such as Bluetooth™. The devices 100 and 200 may thus communicate with each other also when they are not physically connected.

FIG. 2 shows an arrangement according to an embodiment of the invention, which includes a primary pointing device 100 respective a secondary pointing device 200 as described with reference to FIG. 1 above. The devices 100 and 200 are here connected to a digital processor 400 in a laptop computer and control the position of a cursor 411 on the computer's digital screen 410.

The primary pointing device 100 controls the position of the cursor 411 by means of primary position commands C, that are sent to the digital processor 400 via a cable 110a. Obviously, the primary position commands C₁ may equally well be sent to the digital processor 400 via a wireless communication interface, such as optical or radio. The bearing registering sensor 130 registers movements D¹₁ and D¹₂ of the primary pointing device 100 and generates primary position commands C, correlated thereto. The digital processor 400 receives the primary position commands C₁ and produces instructions, which cause the cursor 411 to move on the screen 410 in response the movements D¹₁ and D¹₂ of the primary pointing device 100. Typically, a movement of the primary pointing device 100 along a first direction D¹₁ corresponds to a cursor movement along a first direction d₁ on the screen 410 and a movement of the primary pointing device 100 along a second direction D¹₂ being independent from the first direction D¹₁ corresponds to a cursor movement along a second direction d₂ on the screen 410, which is independent from the first direction d₁.

Correspondingly, the secondary pointing device 200 controls the position of the cursor 411 by means of secondary position commands C₂ that are sent to the digital processor 400 via a wireless interface 210 (e.g. radio or optical). Although less preferred, the primary position commands C₁ may, of course, equally well be sent to the digital processor 400 via a cable interface. At least one of the bearing registering user input controls 230a, 230b and 232 respectively registers the user's commands in a first direction D²₁ and/or a second direction D²₂ and generates secondary position commands C₂ being correlated thereto. The digital processor 400 receives the secondary position commands C₂ and produces instructions, which cause the cursor 411 to move on the screen 410 in response to the user's commands D²₁ and D²₂. Again, a command in a first direction D²₁ normally corresponds to a cursor movement along a first direction d₁ on the screen 410 and a command in a second direction D²₂ being independent from the first direction D²₁ corresponds to a cursor movement along a second direction d₂ on the screen 410, which is independent from the first direction d₁.

Irrespective of whether the devices 100 and 200 are connected to each other or not, either of or both devices may control the cursor 411. This means that the cursor may move on the digital screen 410 either exclusively in response to the primary position commands C₁, exclusively in response to the secondary position commands C₂, or in response to a combination of the primary position commands C₁ and the secondary position commands C₂.

According to a preferred embodiment of the invention, the functionality of at least one of the devices 100 and 200 depends on whether the secondary pointing device 200 is docked with (i.e. physically connected to) the primary pointing device 100 or not. For example, one or more functions in the secondary pointing device 200 may be turned off when this device is docked with the primary pointing device 100.

According to another preferred embodiment of the invention, the primary position commands C₁ represent a first type of cursor positioning, e.g. a relatively slow movement or a movement along a first specific direction, and the secondary position commands C₂ represent a second and different type of cursor positioning, e.g. a relatively fast movement or a movement along a second specific direction. The different types of cursor positioning may also differ with respect to accuracy, such that for example, the first type represents a comparatively high accuracy with respect to movements of the cursor 411, whereas the second type of cursor positioning represents a comparatively low accuracy with respect to movements of the cursor 411.

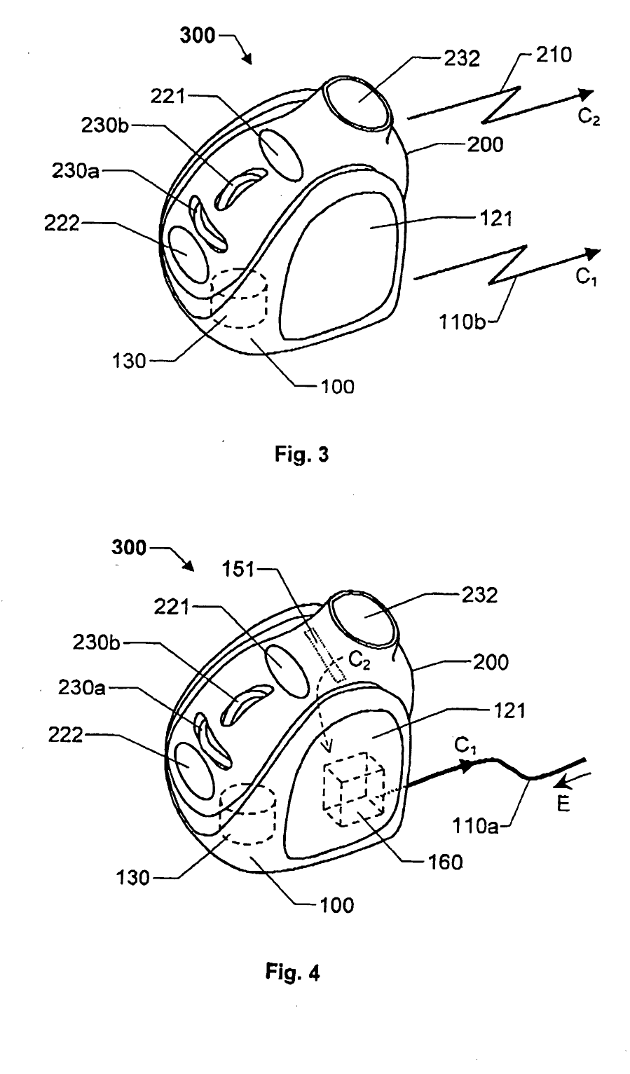

FIG. 3 illustrates a first alternative embodiment of a multifunction pointing device 300 according to the invention, which includes the proposed primary pointing device 100 and the proposed secondary pointing device 200. The multifunction pointing device 300 may control the position of a cursor on a digital screen in a multitude of ways. Any of the bearing registering means 130, 230a, 230b and 232 and the mouse buttons 121, 122, 212 and 222 on the sub-devices 100 and 200 may namely be used for entering commands into the digital processor, which in turn actually controls the cursor. Naturally, the user can choose to temporarily disable one or more of the controls 130, 230a, 230b, 232, 121, 122, 212 or 222 if he/she so prefers.

Here, all commands generated by the primary pointing device 100 are sent via a first wireless communication interface 210, e.g. Bluetooth™. I.e. both the primary position commands C₁ and any selection or activation commands produced by the mouse buttons 121 and 122 are transmitted over this interface 210. Correspondingly, all commands generated by the secondary pointing device 200 are sent via a second wireless communication interface 110b, e.g. Bluetooth™. Hence, the secondary position commands C₂ as well as any selection or activation commands generated by the mouse buttons 221 and 222 or the click-function in the bearing registering user input control 232 are transmitted over the interface 210.

As mentioned with reference to FIGS. 1 and 2 above, the secondary pointing device 200 is detachable from the primary pointing device 100 and both devices are separately operable. Consequently, when the secondary pointing device 200 is detached from the primary pointing device 100, the cursor may be controlled either exclusively by the primary position commands C₁, exclusively by the secondary position commands C₂ or by a combination of the primary position commands C, and the secondary position commands C₂.

FIG. 4 shows a second alternative embodiment of a multifunction pointing device 300 according to the invention, which includes the proposed primary pointing device 100 and the proposed secondary pointing device 200. Here, the contact 151 in the docking interface 150 receives the secondary position commands C₂ from the secondary pointing device 200, as well as any other signals produced by this device 200, and forwards these signals to a transformation unit 160 in the primary pointing device 100. The transformation unit 160 converts the secondary position commands C₂ into primary position commands C₁, which are subsequently forwarded via a cable interface 110a in order to control a cursor on a digital screen. Preferably, any signals produced by the mouse buttons 221 and 222 or the click-function in the bearing registering user input control 232 in the secondary pointing device 200 are also transmitted over this cable interface 110a.

Obviously, the cable interface 110a may be replaced by a wireless communication interface 110b, such as described with reference to FIG. 3 above, without altering the proposed operating principle of this embodiment. However, an advantage attained by the cable interface 110a is that the cable may include one or more wires for transporting electrical energy E to the primary pointing device 100, for example from the computer to which the device 100 is connected. Consequently, the primary pointing device does not need a power supply of its own and can thus be made lighter, less complex and/or less expensive.

According to one preferred embodiment of the invention, both the primary pointing device 100 and the secondary pointing device 200 communicate wirelessly as described with reference to FIG. 3 above. However, the primary pointing device 100 transmits the secondary position commands C₂ via the secondary pointing device 200 (as described with reference to FIG. 4 above). Naturally, such communication may take place also when the devices 100 and 200 are physically separated. According to an alternative preferred embodiment of the invention, the secondary pointing device 200 instead communicates with the digital processor via a cable interface (as in FIG. 4), however receives the secondary position commands C₂ over a wireless interface, such as Bluetooth™.

According to another preferred embodiment of the invention, a particular primary pointing device 100 may function as a receiver and converter for secondary position commands C₂ from more than one secondary pointing device 200.

The term “comprises/comprising” when used in this specification is taken to specify the presence of stated features, integers, steps or components. However, the term does not preclude the presence or addition of one or more additional features, integers, steps or components or groups thereof.

The invention is not restricted to the described embodiments in the figures, but may be varied freely within the scope of the claims.

1-17. (canceled)

18. A primary pointing device for controlling the position of a cursor on a digital screen in response to primary position commands (C₁) wherein the commands are processed by a digital processor, the primary position commands (C₁) being generated by a relative movement between the primary pointing device and a substantially flat external surface, the primary pointing device is adapted to dock with a secondary pointing device for controlling the position of the cursor on the digital screen in response to secondary position commands (C₂) processed by the digital processor, the secondary position commands (C₂) being generated by manipulation of at least one bearing registering user input control on the secondary pointing device.

19. A primary pointing device according to claim 18, further comprising a battery charger having a docking interface adapted for reception of the secondary pointing device and charging at least one rechargeable battery cell therein.

20. A primary pointing device according to claim 19, wherein the secondary pointing device comprises a U-shaped holding member being adapted for attachment to a human hand, the docking interface being adapted to receive the U-shaped holding member and thus accomplish a physical connection between the primary pointing device and the secondary pointing device.

21. A primary pointing device according to claim 18, wherein the docking interface is further adapted to receive the secondary position commands (C₂) from the secondary pointing device when the secondary pointing device is connected to the primary pointing device.

22. A primary pointing device according to claim 21, further comprising a transformation unit, the transformation unit converting the secondary position commands (C₂) received via the docking interface into primary position commands (C₁) and thus rendering the commands adapted for forwarding to the digital processor.

23. A primary pointing device according to claim 18, wherein the primary position commands (C₁) represent a first type of cursor positioning, and the secondary position commands (C₂) represent a second type of cursor positioning.

24. A primary pointing device according to claim 23, wherein the first type of cursor positioning represents a relatively high accuracy with respect to movements of the cursor on the screen, and the second type of cursor positioning represents a relatively low accuracy with respect to movements of the cursor on the screen.

25. A primary pointing device according to claim 23, wherein the first type of cursor positioning causes the cursor to move along a first direction (d₁) on the digital screen, and the second type of cursor positioning causes the cursor to move along a second direction (d₂) on the digital screen, the second direction (d₂) being independent from the first direction (d₁).

26. A primary pointing device according to claim 18, further comprising a wireless communication interface for transmitting the primary position commands (C₁) to the digital processor.

27. A primary pointing device according to claim 18, further comprising a cable interface for transmitting the primary position commands (C₁) to the digital processor.

28. A multifunction pointing device for controlling the position of a cursor on a digital screen in response to primary and secondary position commands (C₁; C₂) processed by a digital processor, comprising
a primary pointing device generating the primary position commands (C₁) by means for relative movement between the primary pointing device and a substantially flat external surface, and
a secondary pointing device generating secondary position commands (C₂) via at least one bearing registering user input control, the secondary pointing device being physically connected to the primary pointing device,
the secondary pointing device being detachable from the primary pointing device, and
the primary pointing device and the secondary pointing device being separately operable, such that when the secondary pointing device is detached from the primary pointing device the cursor moves on the screen either in response to the primary position commands (C₁), in response to the secondary position commands (C₂) or in response to a combination of the primary position commands (C₁) and the secondary position commands (C₂).

29. A multifunction pointing device according to claim 28, wherein the secondary pointing device comprises at least one rechargeable battery cell, and the primary pointing device comprises a battery charger for charging the at least one rechargeable battery cell when the secondary pointing device is connected to the primary pointing device.

30. A multifunction pointing device according to claim 28, wherein the secondary pointing device comprises a wireless communication interface for transmitting the secondary position commands (C₂) to the digital processor.

31. A multifunction pointing device according to claim 28, wherein the primary pointing device comprises a wireless communication interface for transmitting the primary position commands (C₁) to the digital processor.

32. A multifunction pointing device according to claim 28, wherein the primary pointing device comprises a cable interface for transmitting the primary position commands (C₁) to the digital processor.

33. A multifunction pointing device according to claim 32, wherein the cable interface includes at least one wire for transporting electrical energy (E) to the primary pointing device.

34. A multifunction pointing device according to claim 28, further comprising:
a docking interface for receiving the secondary position commands (C₂) from the secondary pointing device when the secondary pointing device is connected to the primary pointing device, and
a transformation unit for converting the secondary position commands (C₂) into primary position commands (C₁) being adapted for forwarding to the digital processor.
